(19) United States
(12) Patent Application Publication
(10) Pub. No.: US 2007/0140241 A1
(43) Pub. Date: Jun. 21, 2007

(54) Fast processing of multicast data

(75) Inventor: Eduardo Asbun, San Diego, CA (US)

Correspondence Address: GENERAL INSTRUMENT CORPORATION DBA THE CONNECTED;HOME SOLUTIONS BUSINESS OF MOTOROLA, INC., 101 TOURNAMENT DRIVE, HORSHAM, PA, 19044, US

(73) Assignee: General Instrument Corporation

(21) Appl. No.: 11/303,325

(22) Filed: Dec. 16, 2005

(51) Int. Cl. H04L 12/56

(52) U.S. Cl. 370/390

(57) ABSTRACT

A memory stores destination addresses and a counter value for each of the stored addresses. A counter value for a stored address is incremented in response to receiving a message having a destination address matching the stored address. A controller determines a destination address of a received message and searches the stored addresses for a stored address matching the destination address of the received message. The received message may be a message in a multicast stream. The search includes searching the stored addresses starting with a stored address having a highest counter value and searching subsequent stored addresses, each subsequently searched stored address having a lower counter value.

### BACKGROUND

Multicasting is a transmission technique used to transmit data from a source to many destinations. Multicasting generally reduces network traffic because a single message is transmitted from the source for multiple destinations, and the message is copied by the network infrastructure as needed to route the message to the multiple destinations. The copying may be performed closer to the destinations to reduce network traffic.

A network device receiving an IP multicast packet processes the packet. The processing may include determining whether to ignore the packet or further process or route the packet. The network device typically belongs to a large number of multicast groups and may process a large amount of multicast traffic, such as Gigabit Ethernet (GE) multicast streams. Some of the streams may be ignored by the network device if the stream belongs to a multicast group not routed or further processed by the network device. Reducing the processing time, that is, the time spent deciding whether a multicast packet is either ignored or further processed by the network device, may be crucial especially when processing multimedia streams. For example, streams carrying video-on-demand that are not timely processed may result in degradation of the video at the customer site.

### SUMMARY

According to an embodiment, a memory stores destination addresses and a counter value for each of the stored addresses. A counter value for a stored address is incremented in response to receiving a message having a destination address matching the stored address. A controller determines a destination address of a received message and searches the stored addresses for a stored address matching the destination address of the received message. The search includes searching the stored addresses starting with a stored address having a highest counter value and searching subsequent stored addresses, each subsequently searched stored address having a lower counter value.

### BRIEF DESCRIPTION OF THE DRAWINGS

Embodiments are illustrated by way of example and not limited in the following figure(s), in which like numerals indicate like elements, in which:

FIG. 1 illustrates a system, according to an embodiment;

FIG. 2A illustrates a node, according to an embodiment;

FIG. 2B illustrates snapshots of a table of destination addresses; according to an embodiment;

FIG. 3A illustrates a system, according to another embodiment;

FIG. 3B illustrates a node, according to another embodiment;

FIG. 4 illustrates a method for determining whether to process a message, according to an embodiment; and

FIG. 5 illustrates a method for reordering a table, according to an embodiment.

### DETAILED DESCRIPTION

For simplicity and illustrative purposes, the principles of the embodiments are described by referring mainly to examples thereof. In the following description, numerous specific details are set forth in order to provide a thorough understanding of the embodiments. It will be apparent however, to one of ordinary skill in the art, that the embodiments may be practiced without limitation to these specific details. In other instances, well known methods and structures have not been described in detail so as not to unnecessarily obscure the embodiments.

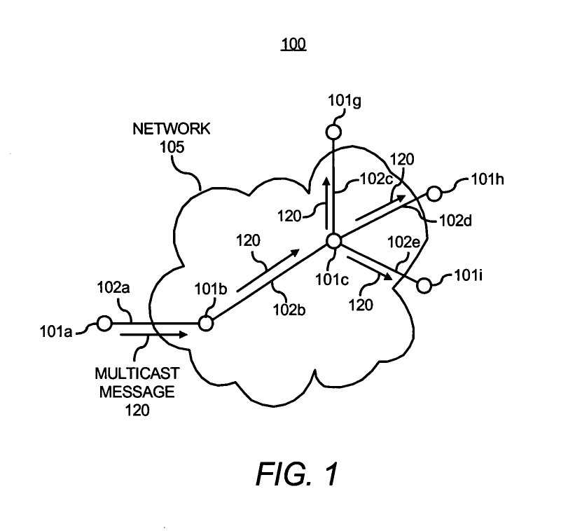

FIG. 1 illustrates a system 100, according to an embodiment. The system 100 includes nodes 101, such as the nodes 101a-i, and a network 105. The nodes 101 may include electronic devices, such as but not limited to servers and other computer systems, routers, encryptor modulators, set-top boxes, personal digital assistants, cellular phones, and other end-user devices, etc. Some of the nodes 101 may be included in the network infrastructure of the network 105, such as routers, switches, encryptor modulators, etc. Other nodes may be outside the network infrastructure but connected to the network infrastructure of the network 105, such as content providers, web servers, end-user devices (e.g., personal computers, set-top boxes, cellular phones, etc.). Nodes outside the network infrastructure may include nodes where messages transmitted in the network 105 originate and nodes that are the final destinations of the messages. The network 105 may include one or more of public (e.g., Internet), private, local area networks, wide area networks, personal area networks, wired, wireless networks, etc., using protocols as is know in the art for sending data in the network 105.

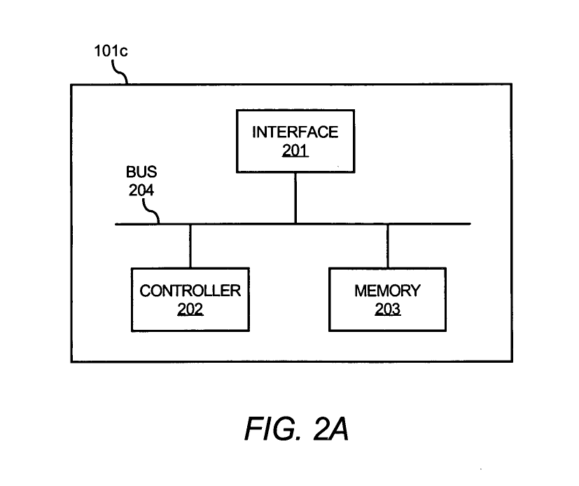

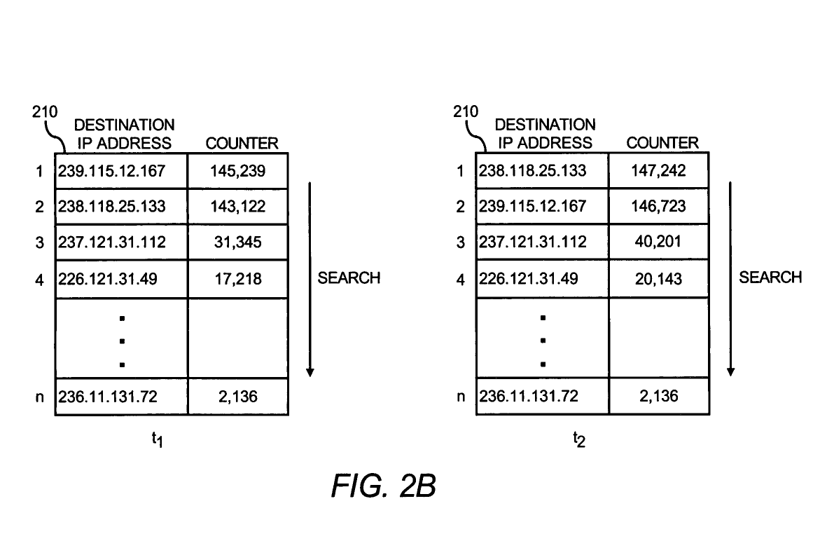

One or more of the nodes 101 are operable to send and/or receive multicast messages. Multicasting includes transmission of a single message to multiple destinations (one-to-many), simultaneously. Multicasting attempts to deliver the message over each link of the network once and create copies when the network path to the destinations split. For example, FIG. 1 shows links 102a-e in the path of a multicast message 120 transmitted from the node 101a to the nodes 101g-101i. The single multicast message 120 is transmitted from the node 101a. Copies of the multicast message 120 are created by the node 101c when the path to the destination nodes 101g-101i splits across the links 102c-e. For example, the node 101c is a multicast router or other routing device. The multicast message 120 includes a destination address, which may include an IP multicast group address, and the node 101c determines whether to process the message for routing based on stored addresses, as described in further detail with respect to FIG. 2. In the example shown in FIG. 1, the node 101c determines to process the multicast message 120 and distributes the multicast message 120 to the nodes 101g-101i. The nodes 101g-101i may have previously sent requests to the node 101c requesting that multicast messages having the destination IP address of the multicast message 120 be transmitted to the requesting node. All other nodes in the system 100 not in the path shown in FIG. 2 either do not receive the multicast message 120 or may ignore the multicast message 120 if received.

Multicasting is generally more efficient than unicasting or broadcasting because less network traffic is generated with multicasting. Unicasting (one-to-one) requires that a single message is transmitted for each destination, so three messages instead of one message would be transmitted on the links 102a and 102b if the message 120 was unicast. Broadcasting (one-to-all) may send the message 120 to all the nodes in the network 105. It will be apparent to one of ordinary skill in the art, however, that the nodes 101 may be operable to send and/or receive one or more of broadcast and unicast messages. Also it will be apparent to one of ordinary skill in the art that the number of nodes in the system 100 may be many more than shown and the network infrastructure of the network 105 may include devices and network equipment not shown as is known in the art.

FIG. 2A illustrates an embodiment of a node that is operable to receive and process multicast messages. The node shown in FIG. 2A, for example, is the node 101c shown in FIG. 1 receiving the multicast message 120 and processing the multicast message 120 to determine whether the multicast message 120 is destined for itself or other nodes connected thereto, such as the nodes 101g-101i. The architecture of the node 101c shown in FIG. 2 may be applied to other nodes in the system 100.

Referring to FIG. 2A, the node 101c includes an interface 201, a controller 202, a memory 203 and a bus 204. The interface 201 may include one or more interfaces for sending and/or receiving data. For example, the interface 201 may include one or more network interfaces that are operable to both send and receive network messages or that are interfaces dedicated to either sending or receiving messages. The messages may include various types of data.

One example of data that may be multicast in the system 100 and processed by the node 101c includes multimedia. Multimedia streams may be multicast in the system 100.

In one embodiment, a multicast message may include packets transmitted over a network. Multimedia streams may be comprised of packets. The packets may be transmitted in Ethernet frames. Ethernet frames may be encapsulated in one or more packets comprising an Ethernet header, Ethernet data and CRC data.

The header of packets includes a destination address. The destination address, for example, is a destination IP address for TCP/IP packets. The destination IP address may be a destination IP multicast address for multicast packets. A destination IP multicast address is also referred to as an IP multicast group address, which is used for IP multicasting, as is known in the art.

As described above, the multicast messages may be transmitted in multicast streams. Multimedia streams may be carried using Gigabit Ethernet or any other Ethernet technology, such as 10 or 100 megabits per second. Multicast messages that are part of a multimedia multicast stream may carry MPEG Transport Streams (TS). One example of an MPEG transport streams is an MPEG-2 TS including MPEG-2 TS packets sent over the Internet and/or other networks using UDP over IP, which are two well-known TCP/IP protocols. It will be apparent to one of ordinary skill in the art that other types of data may be multicast using other formats and multicast data may be processed by the node 101c and other nodes in the system 100. Video-teleconferencing data and data for other applications that push the data to many users are some examples of data that may be multicast.

The controller 202 processes messages received via the interface 201. The controller 202 may include a processor or other control circuitry known in the art for processing messages. Processing a message may include determining whether to ignore a received message or to further process the message by performing a function using data in the message. Performing a function may include routing the message to other nodes, which may include one or more of encrypting the message and modulating the message, running a software application that performs one or more functions using the data, etc.

The controller 202 uses information stored in the memory 203 to determine whether to ignore a received message or to further process the message. In one embodiment, the information in the memory 203 includes a table 210, shown in FIG. 2B, storing destination IP addresses and counter values for each destination IP address. When the node 101c receives a multicast message, the controller 202 identifies a destination IP address, for example, from the header of the received message. The controller 202 searches the table 210 for an address that matches the destination address of the received message. This may include comparing the address in each entry of the table 210 to the destination address of the message. If there is a match, the node 101c further processes the message. For example, the controller 202 may identify nodes that are to receive the multicast message, such as the nodes 101g-101i shown in FIG. 1. These nodes may be members of a multicast group for the destination address of the received message. The destination address in the received message may also be found in table 210.

According to an embodiment, the controller 202 searches the table 210 for an address matching the destination address in the received message starting with an entry in the table 210 having the highest counter value and searching subsequent entries in the table, wherein each subsequent entry has a lower counter value. For example, referring to the snapshot of the table 210 for time, t1, shown in FIG. 2B, the controller starts at entry 1 and continues the search if a match is not found by comparing the destination address of the message to the address in the entry 2, then the address in the entry 3, etc. Each consecutively, searched entry has a lower counter value, shown in the second column of the table 210. If a match is not found, the received message is ignored and not further processed by the controller 202.

The counter values in the table 210 represent the number of times data was received for the corresponding IP address. For example, the entry 1 indicates that data was received 145,239 times for the IP address 239.115.12.167. For example, 145,239 messages having a destination IP address 239.115.12.167 were received. The 145,239 messages may include 145,239 packets, which may include frames in a multimedia stream, packets, etc. The controller 202 may increment a counter value for an address in the table 210 when a message is received that has a destination address matching the stored address.

In a typical multimedia communication system, some multicast streams, which may carry MPEG TSs, carry most of the traffic. This may be due to several reasons. For example, some streams may be encoded with higher quality, requiring higher bandwidth for transmission; some streams may carry High Definition (HD) content, requiring higher bandwidth, etc. The consequence of the above observations is that many more Ethernet frames are received for some multicast streams, while other streams receive significantly less frames.

Searching the addresses in the table 210 shown in FIG. 2B may be performed starting at the highest counter value and subsequently searching entries, each having a lower counter value than the previous entry. Thus, the destination address of a received message are first compared the stored addresses matching addresses for streams generating the most traffic. This results in a reduction of the time needed to look up an address in the table 210, because the addresses having the greatest probability of being a match to the destination address of the received message are compared first to the destination address of the received message. This time savings is significant, especially when processing gigabytes of data per second, which is not uncommon for nodes routing multimedia, multicast streams. This time savings may also minimize video degradation problems at the customer site that can be caused by the inability to timely process multimedia, multicast streams at a cable headend, hub, or other node responsible for distributing multimedia streams to customers.

FIG. 2B shows a snapshot of the table 210 at time, t1, and at a subsequent time, t2. It should be noted that at time t1, the most messages were received for the destination IP address 239.115.12.167 and at time t2, the most packets were received for the destination IP address 238.118.25.133.

According to an embodiment, the controller 202 shown in FIG. 2A is operable to re-order the entries in the table 210 based on the counter values. For example, at time t1, shown in FIG. 2B, the controller 202 ordered the entries 1-n from highest to lowest counter values. At time t2, the controller 202 re-ordered the entries 1-n based on the counter values. The destination IP addresses for entries 1 and 2 switched based on the counter values from the time t1 to the time t2. The controller 202 may search the table 210 in order from entries 1, 2, 3, 4 . . . to n.

If an entry is deleted by the controller 202, the entries below the deleted entry are re-ordered during the next re-order of the table 210. The controller 202 adds new entries to the bottom of the table 210. The new entries may be shifted up in the table based on their counter value during the next re-order. Re-ordering may be performed periodically or in response to an event, such as adding or deleting entries, re-booting, etc.

The table 210 is one example of a data structure that may be used to store addresses and corresponding counter values. Other data structures may be used. Also, the table 210 may be used to store additional information for routing as is known in the art. Furthermore, the addresses stored in the table 210 may be comprised of IP multicast group messages. The IP multicast group messages may include multicast group addresses stored at the node 101c. Members of an IP multicast group receive multicast messages for that group. For example, referring to FIG. 1, the nodes 101g-101i are included in an IP multicast group having an IP multicast address in the table 210. The multicast message 120 has a destination IP address that matches the IP multicast address of the multicast group for the nodes 101g-101i, so the node 101c distributes the message 120 to the nodes 101g-101i. The table 210 may include destination IP addresses for IP addresses other than multicast IP addresses. For example, the destination IP addresses stored in the table 210 may be used for unicast messages or broadcast messages. Generally, messages that are transmitted over a network include a destination address used for routing the messages to the proper destination. These destination addresses may be stored in the table 210.

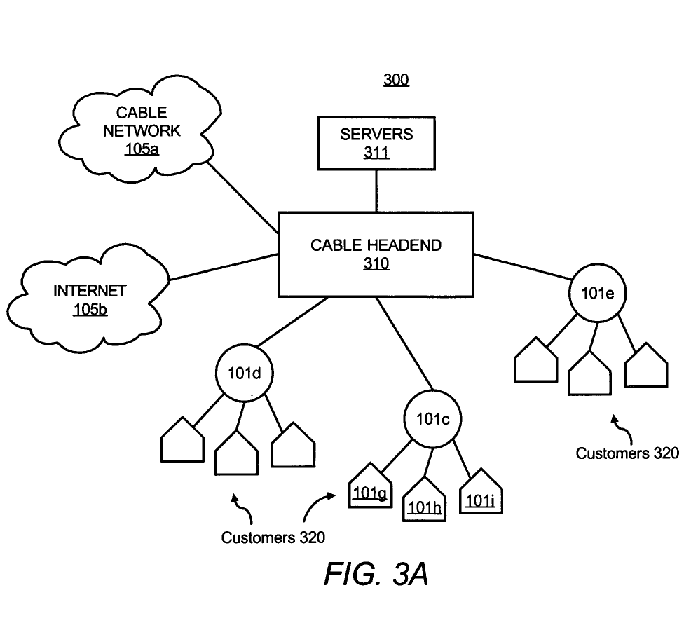

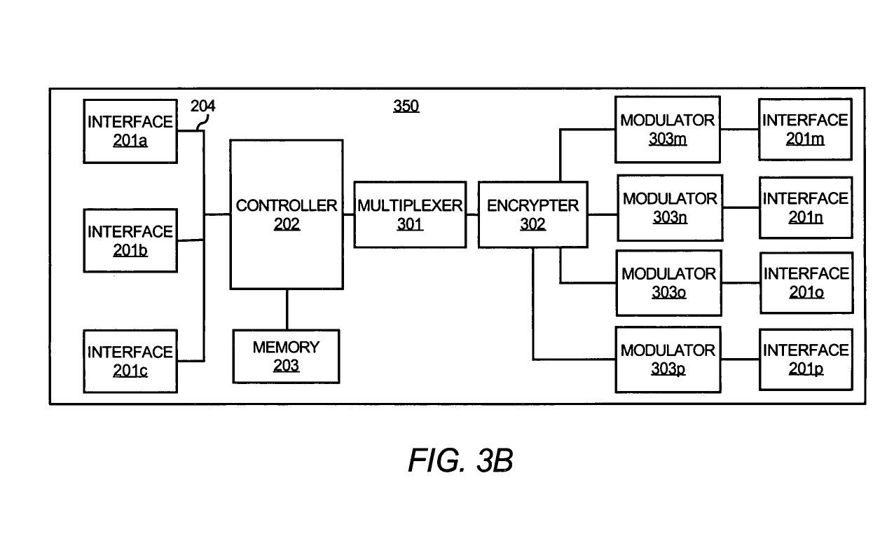

FIG. 3A illustrates a system 300 that is another embodiment of the system 100 shown in FIG. 1. The system 300 may use nodes, such as the nodes 101c-101e operable to determine whether to process or ignore messages, such as described above. The system 300 comprises a cable network that includes a cable headend, nodes 101c-e, which may be provided in a hub or connected to a hub for distributing multimedia streams and/or other data to the customers 320. The cable headend 310 may receive data for multimedia streams and other data from the servers 311, the Internet 302, or other sources. The nodes 101c-e may be connected to the cable headend 310 via a SONET, not shown. The customers 320 may have nodes comprised of electronic devices, such as personal computers, set-top boxes, etc., for receiving the multimedia streams and other data.

FIG. 3B illustrates another embodiment of a node comprising an encryptor modulator 350. The encryptor modulator 350 may be used for the node 101c in the system 300. The encryptor modulator 350 includes many of the elements of the architecture shown in FIG. 2A but also includes a multiplexer 301, an encryptor 302, modulators 303m-303p and interfaces 201a-c and 201m-p for transmitting modulated, multimedia, streams to the customers 320, which may be in the form MPEG TS streams.

The encryptor modulator 350 receives GE multimedia streams on one or more of the interfaces 201a-c from the cable headend 310 shown in FIG. 3A or from another source. The streams may include video or other data. The controller 202 determines whether to process the streams based on the addresses in the table 210 shown in FIG. 2B that may be stored in the memory 203. Assuming the controller 202 determines to process the streams, the multiplexer 301 shown in FIG. 3B constructs MPEG TS streams from the streams received in the interfaces 201a-c. The multiplexer 301, for example, constructs 8 MPEG TS streams where a designated range of UDP ports for the interfaces 201a-c are mapped to a specific modulator 303m-303p. The modulators 303m-303p may include QAM modulators.

Upon completion of the multiplexing function, the multiplexer 301 outputs the MPEG TS streams to the encryptor 302, where the streams are encrypted. The streams are modulated by the modulators 303m-303p and output to the customers 320 via the interfaces 201m-201p. One or more of the streams are optionally not encrypted.

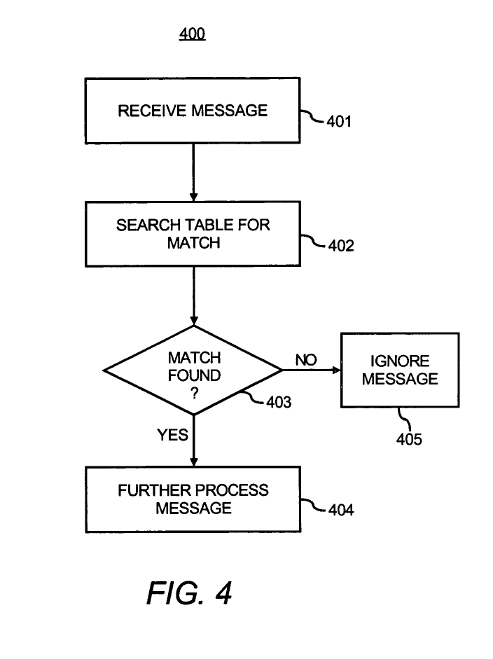

FIG. 4 illustrates a method 400 according to an embodiment for determining whether to process a message. The processing may include determining whether to ignore a received message or further process the message. Examples of further processing a message are described with respect to step 404 below. The method 400 is described with respect to the systems and devices described in FIGS. 1-3B by way of example and not limitation. It will be apparent to one of ordinary skill in the art that the method 400 may be performed by other systems or devices.

At step 401, a node, such as the node 101c shown in FIGS. 1 and 3A, receives a message. The message may be a multicast message. The message may be included in a multimedia stream. For example, the message may include an Ethernet frame that carries an MPEG TS packet or other data. TCP/IP or another protocol may be used for generating and transmitting the message.

At step 402, the controller 202 of the node 101c, such as shown in FIGS. 2A and 3B, searches the table 210 shown in FIG. 2B for a destination address matching a destination address in the received message. For example, the controller 202 searches the table 210 for an address matching destination IP address in a received message starting with an entry in the table 210 having the highest counter value and searching subsequent entries in the table, wherein each subsequent entry has a lower counter value. Referring to the snapshot of the table 210 for time, t1, shown in FIG. 2B, the controller starts at entry 1 and continues the search if a match is not found to entry 2, then entry 3, etc. Each consecutively searched entry has a lower counter value, shown in the second column of the table 210. If a match is not found, the received message is ignored and not further processed by the controller 202.

At step 403, the controller 202 determines whether a match is found. If a match is found, the controller 202 further processes the message at step 404. Further processing may include incrementing a counter value for the matching destination IP address in the table 210, transmitting the message to one or more other nodes, processing data in the message, etc. If a match is not found at step 403, the controller 202 ignores the received message at step 405. That is the controller does not further process the message and deletes the message if it was cached.

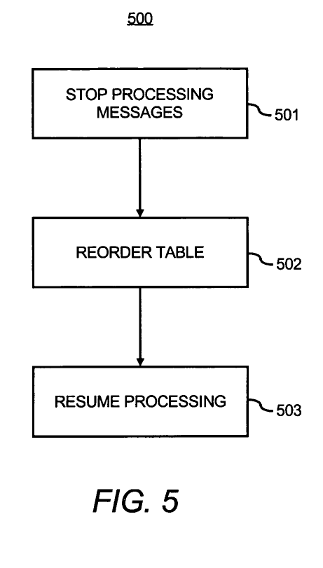

FIG. 5 illustrates a method 500 according to an embodiment for reorganizing a table. The method 500 is described with respect to the systems and devices described in FIGS. 1-3B by way of example and not limitation. It will be apparent to one of ordinary skill in the art that the method 500 may be performed by other systems or devices.

At step 501, the controller of a node, such as the controller 202 of the node 101c shown in FIGS. 2A and 3B, stops processing received messages. The messages may be MPEG TS packets or other data.

At step 502, the controller 202 reorders the table 210 shown in FIG. 2B. For example, the controller 202 gets a snapshot of the table 210 at a particular time, such as the table 210 at time t1, shown in FIG. 2B. The controller 202 reorders the table 210 from highest to lowest counter values, such as shown for the time t2 in FIG. 2B.

At step 503, the controller 202 resumes processing messages. The controller 202 uses the reordered table to process messages. One or more of the steps of the method 500 may be performed periodically, such as every 10 minutes, every hour, or daily. Thus, the table 210 is reordered periodically. Also, it will be apparent to one of ordinary skill in the art that or more of the steps of the methods 400 and 500 may be varied or performed in different orders when practicing the embodiments. Furthermore, one or more steps may not be specifically specified but may be performed in the methods 400 and 500. For example, the addresses in the table 210 are stored in the memory 203 in the node 101c. This may include storing a new table when the node 101c is first booted up. Also, the table may be updated to store or remove addresses as needed.

One or more of the steps of the methods 400 and 500 and other steps described herein and software described herein may be implemented as software embedded or stored on a computer readable medium, such as the memory 203 or other storage in nodes and executed by the controller 202. The steps may be embodied by a computer program, which may exist in a variety of forms both active and inactive. For example, they may exist as software program(s) comprised of program instructions in source code, object code, executable code or other formats for performing some of the steps when executed. Any of the above may be stored on a computer readable medium, which include storage devices and signals, in compressed or uncompressed form. Examples of suitable computer readable storage devices include conventional computer system RAM (random access memory), ROM (read only memory), EPROM (erasable, programmable ROM), EEPROM (electrically erasable, programmable ROM), and magnetic or optical disks or tapes. Examples of computer readable signals, whether modulated using a carrier or not, are signals that a computer system hosting or running the computer program may be configured to access, including signals downloaded through the Internet or other networks. Concrete examples of the foregoing include distribution of the programs on a CD ROM or via Internet download. In a sense, the Internet itself, as an abstract entity, is a computer readable medium. The same is true of computer networks in general. It is therefore to be understood that those functions enumerated herein may be performed by any electronic device capable of executing the above-described functions.

While the embodiments have been described with reference to examples, those skilled in the art will be able to make various modifications to the described embodiments without departing from the true spirit and scope. The terms and descriptions used herein are set forth by way of illustration only and are not meant as limitations. In particular, although the methods have been described by examples, steps of the methods may be performed in different orders than illustrated or simultaneously. Those skilled in the art will recognize that these and other variations are possible within the spirit and scope as defined in the following claims and their equivalents.

What is claimed is:

1. An apparatus comprising:
at least one interface operable to receive messages;
a memory operable to store destination addresses and a counter value for each of the stored addresses, wherein a counter value for a stored address is incremented in response to receiving a message having a destination address matching the stored address; and
a controller operable to determine a destination address of a received message and to search the stored addresses for a stored address matching the destination address of the received message, wherein the search includes searching the stored addresses starting with a stored address having a highest counter value and searching subsequent stored addresses, each subsequently searched stored address having a lower counter value than a previous stored address.

2. The apparatus of claim 1, wherein the received message comprises a multicast message having a destination multicast IP address and the stored addresses comprise destination multicast IP addresses.

3. The apparatus of claim 2, wherein if the controller identifies a stored address matching the destination multicast IP address of the received message, the apparatus is further operable to transmit the multicast message to at least one node previously determined to receive multicast messages having the destination multicast IP address.

4. The apparatus of claim 3, wherein messages received via the at least one interface include messages in a multimedia stream, the apparatus further comprising:
a multiplexer operable to construct at least one MPEG transport stream from the multimedia stream received via the at least one interface if the messages in the multimedia stream include a destination multicast IP address matching a stored address; and
at least one modulator operable to modulate the at least one MPEG transport stream for transmission to the at least one node.

5. The apparatus of claim 4, further comprising:
an encryptor operable to encrypt the at least one MPEG transport stream.

6. The apparatus of claim 1, wherein the controller is further operable to ignore the received message if the controller determines the destination address of the received message does not match a stored address.

7. The apparatus of claim 1, wherein the controller is further operable to
suspend processing of received messages;
determine a snapshot of a data structure storing the addresses and counter value for each stored address; and
reorder the stored addresses in the data structure based on the counter value for each stored address.

8. The apparatus of claim 7, wherein the reordered stored addresses are ordered from highest counter value to lowest counter value, and the controller is operable to search the stored addresses in order starting from the address having the highest counter value.

9. The apparatus of claim 2, wherein the at least one interface comprises a network interface receiving multimedia stream packets, and the controller is operable to increment a counter value for a stored address in response to receiving a packet having the stored destination address.

10. An electronic device comprising:
interface means for receiving multicast streams, each stream including a destination multicast address;
memory means for storing destination multicast addresses and a counter value for each of the stored addresses, wherein a counter value for a stored address is incremented in response to receiving a multicast stream having a destination multicast address matching the stored address; and
controller means for determining a destination multicast address of a received multicast stream and for searching the stored addresses for an address matching the destination multicast address in the received multicast stream, wherein searching the stored addresses includes searching starting with a stored address having a highest counter value and searching subsequent stored addresses, each subsequently searched stored address having a lower counter value than a previous stored address.

11. The electronic device of claim 10, wherein if the controller means identifies a stored address matching the destination multicast address in the received multicast stream, the apparatus is further operable to transmit data from the received multicast stream to at least one node previously determined to receive data from a received multicast stream having the destination multicast address matching the stored address.

12. The electronic device of claim 10, wherein the controller means ignores the received multicast stream if the controller determines the destination multicast address in the received multicast stream does not match a stored address.

13. The electronic device of claim 10, wherein the controller means is further operable to
determine a destination multicast address for a packet in a multicast stream received via the interface means; and
increment the counter value for a stored address in the memory means if the stored address matches the destination multicast address.

14. The electronic device of claim 10, wherein the controller means is further operable to
suspend processing of received multicast streams;
determine a snapshot of a data structure in the memory means storing the addresses and a counter value for each address; and
reorder the stored addresses in the data structure based on the counter value for each stored address, wherein the reordered stored addresses are ordered from highest counter value to lowest counter value, and the controller is operable to search the stored addresses in order starting from the address having the highest counter value.

15. The electronic device of claim 10, further comprising:
multiplexer means for constructing at least one MPEG transport stream from a received multimedia stream if the multimedia stream includes a destination multicast address matching a stored address;
encryptor means for encrypting the at least one MPEG transport stream; and
modulator means for modulating the at least one MPEG transport stream for transmission to the at least one node determined to receive the multicast stream.

16. A method comprising:
receiving multicast streams;
storing addresses and a counter value for each of the stored addresses, wherein the counter value for a stored address is incremented in response to receiving a message in the multicast streams having a destination multicast address matching the stored address;
ordering the stored addresses from highest to lowest counter value;
searching stored addresses from highest to lowest counter value for an address matching a destination multicast address of a message in a received multicast stream, and
further processing the message if the destination multicast address matches a stored address.

17. The method of claim 16, further comprising:
ignoring the message if the destination multicast address does not match a stored address.

18. The method of claim 16, further comprising:
suspending processing of the received multicast streams;
determining a snapshot of a data structure in the memory means storing the addresses and the counter value for each address;
reordering the stored addresses in the data structure based on the counter value for each stored address, wherein the reordered stored addresses are ordered from highest counter value to lowest counter value; and
resuming processing, wherein the processing includes searching the stored addresses in order starting from the address having the highest counter value for new messages.

19. The method of claim 18, further comprising:
periodically reordering the data structure based on the counter value for each stored address, wherein the reordered stored addresses are ordered from highest counter value to lowest counter value.

20. The method of claim 16, wherein further processing the message further comprises:
constructing MPEG transport streams from the multicast streams;
encrypting the MPEG transport streams; and
modulating the MPEG transport streams for transmission to nodes in multicast groups for the MPEG transport streams.
